(19) United States
(12) Patent Application Publication
(10) Pub. No.: US 2013/0342475 A1
(43) Pub. Date: Dec. 26, 2013

(54) TOUCH PANEL

(71) Applicants: Seung Min Lee, Gyunggi-do (KR); Sang Hwan Oh, Gyunggi-do (KR); Ho Joon Park, Gyunggi-do (KR); Wan Jac Lee, Gyunggi-do (KR)

(72) Inventors: Seung Min Lee, Gyunggi-do (KR); Sang Hwan Oh, Gyunggi-do (KR); Ho Joon Park, Gyunggi-do (KR); Wan Jac Lee, Gyunggi-do (KR)

(73) Assignee: SAMSUNG ELECTRO-MECHANICS CO., LTD., Gyunggi-do (KR)

(21) Appl. No.: 13/570,099

(22) Filed: Aug. 8, 2012

(30) Foreign Application Priority Data
Jun. 22, 2012 (KR) 10-2012-0067438

(51) Int. Cl. G06F 3/041

(52) U.S. Cl. 345/173

(57) ABSTRACT

Disclosed herein is a touch panel. The touch panel according to a first embodiment of the present invention includes a transparent substrate that is partitioned into an active region and an inactive region outside the active region, a first electrode that is formed in the active region of one surface of the transparent substrate, a second electrode that is formed in the active region of the other surface of the transparent substrate, and a low dielectric constant film that is formed along a peripheral edge of the active region while being formed in the inactive region of the one surface of the transparent substrate. In the touch panel, touch sensitivity is improved by minimizing influence of a polarization phenomenon on changes in capacitance on the peripheral edge of the active region in which a detection region is reduced.

### CROSS REFERENCE TO RELATED APPLICATION

This application claims the benefit of Korean Patent Application No. 10-2012-0067438, filed on Jun. 22, 2012, entitled “Touch Panel”, which is hereby incorporated by reference in its entirety into this application.

### BACKGROUND OF THE INVENTION

1. Technical Field

The present invention relates to a touch panel.

2. Description of the Related Art

With the development of computers using digital technology, computer assisted devices have been developed, and personal computers, portable transmission devices, information processing devices exclusive for individual, and the like perform a text and graphic process using a variety of input devices such as a keyboard, a mouse, and the like.

However, since the use of the computer has gradually widened with the rapid progress of an information society, there are difficulties in effectively driving products only using the keyboard and the mouse currently acting as an input device. Accordingly, there is a demand for an input device which has a simple operation and reduces an erroneous operation while allowing information input to be easily performed by anyone.

In addition, in input device-related technologies, concerns have been changed toward high reliability, durability, innovativeness, design and processing-related technology, and the like in addition to satisfying general functions. Here, to achieve these purposes, as an input device in which information such as text, graphics, and the like can be input, a touch screen has been developed.

The touch panel is mounted on a display surface of a flat panel display device such as a digital organizer, an LCD (liquid crystal display) a PDP (plasma display panel), an EL (electroluminescence), or the like, and on a display surface of an image display device such as a CRT (cathode ray tube), and is used to allow a user to select their desired information while viewing the image display device.

Types of touch panels are classified as a resistive type, a capacitive type, an electro-magnetic type, a SAW (surface acoustic wave) type, and an infrared type. The touch panels having these various types are applied to electronic products based on problems of signal amplification, resolution difference, the difficulty of design and processing technology, optical characteristics, electrical characteristics, mechanical characteristics, environment resistance characteristics, durability, input characteristics, and affordability, and a resistive touch panel and a capacitive touch panel are currently and widely used.

As an example of the conventional capacitive touch panel, a touch panel disclosed in Korean Patent Laid-Open Publication No. 10-2011-0120157 may be given. On the disclosed touch panel, a driving electrode and a detection electrode which intersect each other in two axial directions in an active region on a transparent substrate are formed. In addition, on an inactive region on the transparent substrate, electrode wiring connected to the above-described electrode is formed.

In such a touch panel, a touch by a user may be recognized by detecting variance in signals generated by capacitive coupling of the driving electrode and the detection electrode.

However, in the conventional touch panel, a detection region capable of detecting the variance in the signals at edges of the active region in which the electrode is formed, that is, at edges and sides of a rectangular region into which the active region is partitioned as disclosed in the Korean Patent Laid-Open Publication No. 10-2011-0120157, that is, a region where a capacitive coupling phenomenon occurs may be reduced.

In particular, as disclosed in the Korean Patent Laid-Open Publication No. 10-2011-0120157, when the electrode is formed in a diamond pattern, the above-described detection region at the edges of the active region may be reduced by about ¼.

For this reason, the conventional touch panel has a problem in that touch sensitivity at the edges of the active region is reduced.

In order to overcome this, in the conventional touch panel, the electrode on the active region may be formed to extend to the inactive region. However, in this case, the touch panel has a problem in that a size of the touch panel is increased due to extension of the inactive region, or the active region which is visually recognizable in the touch panel having a fixed size has to be reduced.

### SUMMARY OF THE INVENTION

The present invention has been made in an effort to provide a touch panel in which touch sensitivity may be improved at edges of an active region of the touch panel even though an electrode is not formed to extend to an inactive region.

According to a first embodiment of the present invention, there is provided a touch panel including: a transparent substrate that is partitioned into an active region and an inactive region outside the active region; a first electrode that is formed in the active region of one surface of the transparent substrate; a second electrode that is formed in the active region of the other surface of the transparent substrate; and a low dielectric constant film that is formed along a peripheral edge of the active region while being formed in the inactive region of the one surface of the transparent substrate.

The low dielectric constant film of the touch panel according to the first embodiment of the present invention may be made of an organic material or an inorganic material.

In this instance, the organic material may include any one selected from DVS-BCB (divinyl siloxane biszocylclobutene benzocyclobutene), PFCB (perfluoro cyclobutane), and SiLK.

In addition, the inorganic material may include any one selected from Black Diamond, CORAL, and AURORA.

A dielectric constant (k) of the low dielectric constant film of the touch panel according to the first embodiment of the present invention may have a range of 1 to 3.

The touch panel according to the first embodiment of the present invention may further include an adhesive layer that is laminated on the active region of the one surface of the transparent substrate.

The low dielectric constant film of the touch panel according to the first embodiment of the present invention and the adhesive layer may be formed as the same layer.

The adhesive layer of the touch panel according to the first embodiment of the present invention may be an optical clear adhesive (OCA).

The touch panel according to the first embodiment of the present invention may further include a window glass that is attached to the adhesive layer.

According to a second embodiment of the present invention, there is provided a touch panel including: a transparent substrate that is partitioned into an active region and an inactive region outside the active region; first and second electrodes that are formed in the active region of one surface of the transparent substrate; and a low dielectric constant film that is formed along a peripheral edge of the active region while being formed in the inactive region of the one surface of the transparent substrate.

The low dielectric constant film of the touch panel according to the second embodiment of the present invention may be made of an organic material or an inorganic material.

In this instance, the organic material may include any one selected from DVS-BCB (divinyl siloxane biszocylclobutene benzocyclobutene), PFCB (perfluoro cyclobutane), and SiLK.

In addition, the inorganic material may include any one selected from Black Diamond, CORAL, and AURORA.

A dielectric constant (k) of the low dielectric constant film of the touch panel according to the second embodiment of the present invention may have a range of 1 to 3.

The touch panel according to the second embodiment of the present invention may further include an adhesive layer that is laminated on the active region of the one surface of the transparent substrate.

The low dielectric constant film of the touch panel according to the second embodiment of the present invention and the adhesive layer may be formed as the same layer.

The adhesive layer of the touch panel according to the second embodiment of the present invention may be an OCA.

The transparent substrate of the touch panel according to the second embodiment of the present invention may be a window glass.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a plan view showing a transparent substrate of a touch panel according to a first embodiment of the present invention;

FIGS. 2 and 3 are cross-sectional views showing a touch panel according to a first embodiment of the present invention; and

FIGS. 4 and 5 are cross-sectional views of a touch panel according to a second embodiment of the present invention.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

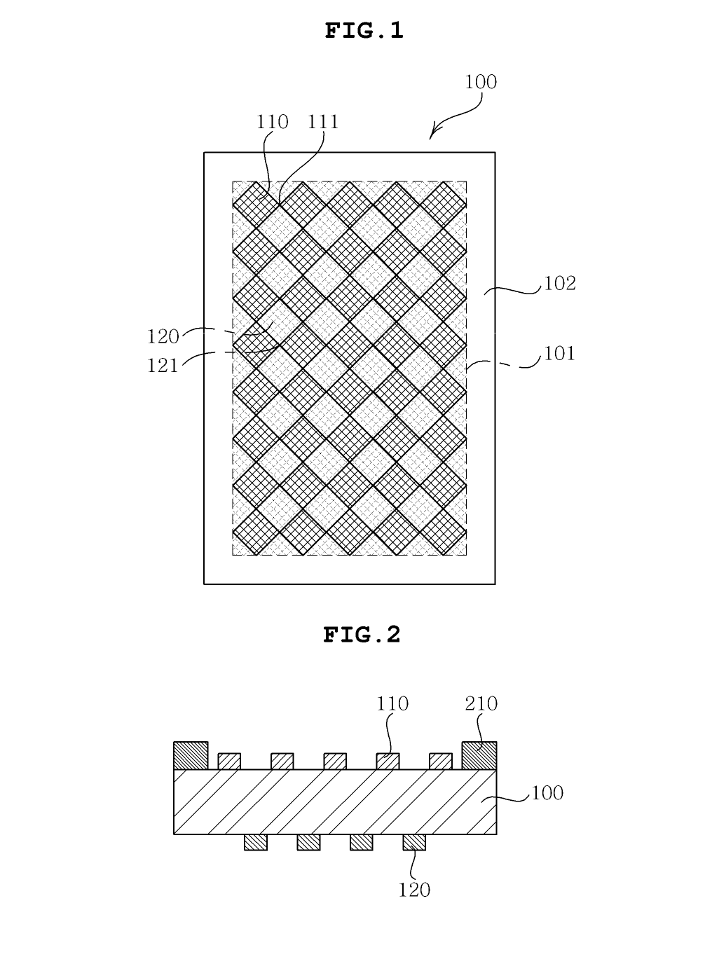

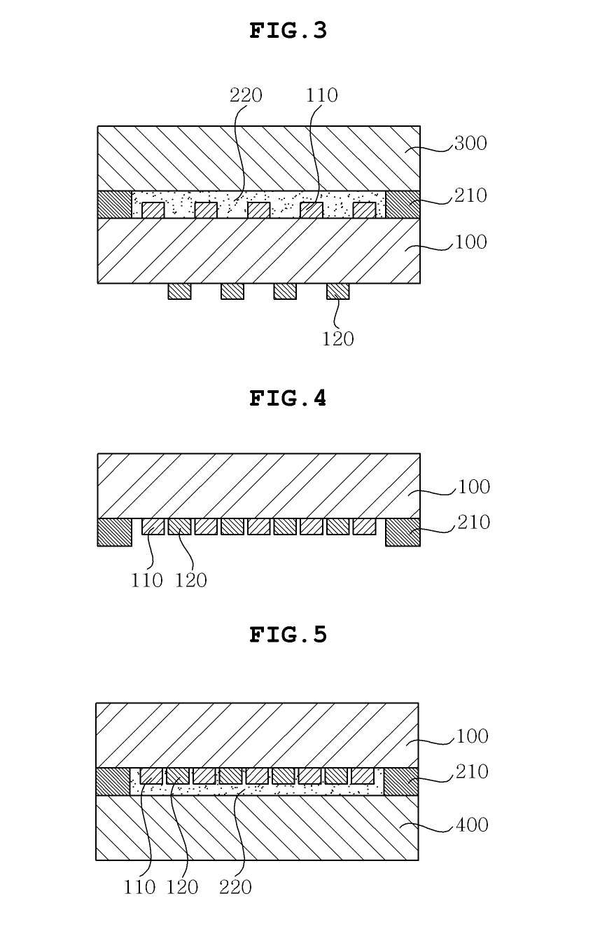

FIG. 1 is a plan view showing a transparent substrate of a touch panel according to a first embodiment of the present invention, and FIGS. 2 and 3 are cross-sectional views showing a touch panel according to a first embodiment of the present invention.

The touch panel according to the present embodiment includes a transparent substrate 100 that is partitioned into an active region 101 and an inactive region 102 outside the active region 101, a first electrode 110 that is formed in the active region 101 of one surface of the transparent substrate 100, a second electrode 120 that is formed in the active region 101 of the other surface of the transparent substrate 100, and a low dielectric constant film 210 that is formed along a peripheral edge of the active region 101 while being formed in the inactive region 102 of the one surface of the transparent substrate 100.

The transparent substrate 100 provides a region in which the first electrode 110 and the second electrode 120 are to be formed. The transparent substrate 100 should have support force capable of supporting the first electrode 110 and the second electrode 120, and transparency which allows a user to recognize an image provided by an image display device.

Based on the above-described support force and the transparency, it is preferable that the transparent substrate 100 be made of polyethylene terephthalate (PET), polycarbonate (PC), polymethyl methacrylate (PMMA), polyethylene terephthalate (PEN), polyethersulfone (PES), a cyclic olefin polymer (COC), a TAC (Triacetylcellulose) film, a polyvinyl alcohol (PVA) film, a polyimide (PI) film, polystyrene (PS), biaxially oriented polystyrene (K resin-containing biaxially oriented PS, BOPS), a glass, a tempered glass, or the like, but the invention is not necessarily limited thereto.

It is preferable that one surface and the other surface of the transparent substrate 100 be activated by being subjected to a high-frequency treatment or a primer processing. The transparent substrate 100 is processed in this manner, and therefore adhesion between the transparent substrate 100 and the first electrode 110 and between the transparent substrate 100 and the second electrode 120 may be further improved.

As shown in FIG. 1, the transparent substrate 100 may be partitioned into the active region 101 and the inactive region 102. The active region 101 may generate touch signals as a region in which the first electrode 110 and the second electrode 120 are formed. The inactive region 102 may occupy the outside of the active region 101 and be partitioned from the active region 101.

The first electrode 110 and the second electrode 120 may generate signals when a user touches the first electrode 110 and the second electrode 120, and allow a controller (not shown) to recognize touch coordinates.

The first electrode 110 is formed in the active region 101 of one surface of the transparent substrate 100. The first electrode 110 may be made of a metal consisting of any one selected from copper (Cu), aluminum (Al), gold (Au), silver (Ag), titanium (Ti), palladium (Pd), and chrome (Cr), or a combination thereof. The first electrode 110 may be formed on one surface of the transparent substrate 100 in a mesh pattern by a plating process, a vapor deposition process, or the like. In this instance, as shown in FIG. 1, the first electrode 110 may be formed in a diamond pattern which is arranged in a first direction on the transparent substrate 100, and in a bridge pattern 111 which enables connection between the diamond patterns.

The second electrode 120 is formed in the active region 101 of the other surface of the transparent substrate 100. The second electrode 120 may be also made of a metal consisting of any one selected from copper (Cu), aluminum (Al), gold (Au), silver (Ag), titanium (Ti), palladium (Pd), and chrome (Cr), or a combination thereof, and may be formed on the other surface of the transparent substrate 100 in a mesh pattern. The second electrode 120 may be formed in a diamond pattern which is arranged in a second direction on the transparent substrate 100, and in a bridge pattern 121 which enables connection between the diamond patterns. In this instance, the diamond pattern constituting the second electrode 120 may be formed in such a manner as to occupy a region of the other surface of the transparent substrate 100 which does not vertically intersect the diamond pattern constituting the first electrode 110.

Any one of the first electrode 110 and the second electrode 120 may be used as a detection electrode, and the other thereof may be used as a driving electrode.

It is not necessary that the first electrode 110 and the second electrode 120 should be formed in the above-described diamond pattern while being formed in the mesh pattern. Obviously, the first electrode 110 and the second electrode 120 may be formed in various types of patterns which have been known in the related art, other than the diamond pattern.

Prior to describing the low dielectric constant film 210, the conventional touch panel may include an adhesive layer that allows a window glass or the like to be attached to the transparent substrate 100. The adhesive layer should have transparency, and an optical clear to adhesive (OCA) may be used as the adhesive layer.

The adhesive layer is formed on the entire surface of the transparent substrate 100 including the active region 101 and the inactive region 102, and generally has a dielectric constant (k) of 3.8 to 5. Accordingly, changes in capacitance occurring at the time of a touch by a user are affected by a polarization phenomenon of the adhesive layer.

In addition, at edges and sides of the active region 101, a region in which a capacitive coupling phenomenon occurs, that is, a detection region is reduced. Accordingly, the conventional touch panel has problems such as a reduction in touch sensitivity due to effect by the polarization of the adhesive layer in addition to a reduction in the detection region at the edges and sides of the active region 101.

Accordingly, in the present embodiment, the low dielectric constant film 210 is formed on the inactive region 102 which surrounds around the edges and sides of the active region 101, that is, the peripheral edge of the active region 101.

As shown in FIG. 2, the low dielectric constant film 210 is formed on the inactive region 102 of the one surface of the transparent substrate 100. The low dielectric constant film 210 is formed on the inactive region 102 which is not the active region 101 which is recognized by a user, and therefore the low dielectric constant film does not need to have transparency. In this instance, the low dielectric constant film 210 is formed along the peripheral edge of the active region 101 of the transparent substrate 100. Accordingly, the low dielectric constant film 210 is formed on the transparent substrate 100 so as to surround the edges and four sides of the active region 101.

The low dielectric constant film 210 has a low dielectric constant (k). In this instance, the low dielectric constant film 210 has the dielectric constant (k) lower than that of the above-described adhesive layer 220. Specifically, the low dielectric constant film 210 may be made of a material having a dielectric constant (k) having a range of 1 to 3.

The low dielectric constant film 210 may be made of an organic material or an inorganic material which has the above-described range. In this instance, the organic material may include any one selected from DVS-BCB (divinyl siloxane biszocylclobutene benzocyclobutene), PFCB (perfluoro cyclobutane), and SiLK which are products of the Dow Chemical corporation. The inorganic material may include any one selected from Black Diamond (Applied Materials corporation), CORAL (Novellus corporation), and AURORA (ASM corporation). Both the organic material and the inorganic material have a dielectric constant (k) of 3.0 or less.

The low dielectric constant film 210 is not limited to the above-described materials. A material such as FLARE, FOX (flowable oxide), HOSP, JSR, parylene, a-C: H (F), polyimide (PI), PAE (poly arylene ether), cyclobutane derivatives, polysilsesquioxane, FAC (fluorinated amorphous carbon), or the like which has a dielectric constant of 3.0 or less may be used as the material of the low dielectric constant film 210 according to the present embodiment.

The low dielectric constant film 210 having the low dielectric constant (k) is formed on the peripheral edge of the active region 101 of the transparent substrate 100, and therefore compared to the conventional touch panel in which the OCA is formed even on the inactive region 102, touch sensitivity may be improved by minimizing influence of the polarization phenomenon of the low dielectric constant film 210 itself on the peripheral edge of the active region 101.

Since the low dielectric constant film 210 has hydrophobic when including a material such as DVS-BCB (divinyl siloxane biszocylclobutene benzocyclobutene) or the like, the low dielectric constant film 210 is formed so as to surround the peripheral edge of the active region 101, thereby preventing invasion into the touch panel.

According to the present embodiment, the touch panel may further include the adhesive layer 220 formed on one surface of the transparent substrate 100. In addition, according to the present embodiment, the touch panel may further include a window glass 300 which is attached to the adhesive layer 220.

The adhesive layer 220 is formed on the transparent substrate 100 to enable the window glass 300 to be integrated with the transparent substrate 100, and is laminated on the active region 101 of one surface of the transparent substrate 100. The adhesive layer 220 is formed on an inner side of the above-described low dielectric constant film 210, and in this instance, may be formed as the same layer as that of the low dielectric constant film 210.

In addition, the adhesive layer 220 may be made of an OCA as described above.

The window glass 300 is provided on the outermost portion of the touch panel, and has a configuration in which touch is performed by a user. The window glass 300 may be, for example, a tempered glass. The window glass 300 may be integrated with the transparent substrate 100 when attached to the above-described adhesive layer 220.

Hereinafter, with reference to the accompanying drawings, a second embodiment of the present invention will be described in detail. However, repeated descriptions with regard to the first embodiment will be omitted.

FIGS. 4 and 5 are cross-sectional views of a touch panel according to a second embodiment of the present invention.

As shown in FIG. 4, according to the present embodiment, a transparent substrate 100 that is partitioned into an active region 101 (see, FIG. 1) and an inactive region 102 (see, FIG. 1) outside the active region 101, first and second electrodes 110 and 120 that are formed in the active region 101 of one surface of the transparent substrate 100, and a low dielectric constant film 210 that is formed along a peripheral edge of the active region 101 while being formed in the inactive region 102 of the one surface of the transparent surface 100.

The transparent substrate 100 according to the second embodiment may be the window glass 300 described in the first embodiment. In this case, according to the present embodiment, a separate substrate which is attached to the window glass is not required. Both the first electrode 110 and the second electrode 120 are formed on the one surface of the transparent substrate 100 which is used as the window glass.

The first electrode 110 may be formed in a diamond pattern which is arranged in a first direction and a bridge pattern which connects the diamond pattern as described in the first embodiment. The second electrode 120 may be formed in a diamond pattern which is arranged in a second direction and a bridge pattern which connects the diamond pattern while being formed on a remaining region except a region where the diamond pattern of the first electrode 110 is formed. In this instance, although not shown, in a region which intersects each other between the bridge pattern of the first electrode 110 and the bridge pattern of the second electrode 120, an insulating layer may be formed between the bridge patterns for the purpose of insulating between the bridge patterns.

In addition, according to the present embodiment, as described in the first embodiment, the low dielectric constant film 210 is formed on the inactive region 102 along a peripheral edge of the active region 101 of the one surface of the transparent substrate 100.

In addition, as shown in FIG. 5, the touch panel according to the present embodiment may further include an adhesive layer 220 such as the OCA, which is formed in the active region 101 of the one surface of the transparent substrate 100, and the adhesive layer 220 and the low dielectric constant film 210 may be formed as the same layer.

As shown in the drawing, an image display device 400 which is arranged in a direction of the other surface of the transparent substrate 100 may be attached to the adhesive layer 220.

As described above, according to the embodiments, the low dielectric constant film 210 is formed along the peripheral edge of the active region 101 in which the detection region is reduced as described above, and therefore touch sensitivity of the peripheral edge of the active region 101 may be improved by minimizing influence of the polarization phenomenon on changes in capacitance occurring between the first and second electrodes 110 and 120. In addition, the low dielectric constant film 210 has a hydrophobic characteristic, and therefore durability of the touch panel may be improved by preventing permeation of moisture into the touch panel.

In addition, according to the embodiments, accompanying the above-described advantages, it is possible to solve disadvantages of the conventional touch panel such that a size of the touch panel is increased or a view area of the touch panel which is visually recognized should be reduced because the inactive region is unnecessarily increased due to extension of the electrode.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A touch panel comprising:
a transparent substrate that is partitioned into an active region and an inactive region outside the active region;
a first electrode that is formed in the active region of one surface of the transparent substrate;
a second electrode that is formed in the active region of the other surface of the transparent substrate; and
a low dielectric constant film that is formed along a peripheral edge of the active region while being formed in the inactive region of the one surface of the transparent substrate.

2. The touch panel as set forth in claim 1, wherein the low dielectric constant film is made of an organic material or an inorganic material.

3. The touch panel as set forth in claim 2, wherein the organic material includes any one selected from DVS-BCB (divinyl siloxane biszocylclobutene benzocyclobutene), PFCB (perfluoro cyclobutane), and SiLK.

4. The touch panel as set forth in claim 2, wherein the inorganic material includes any one selected from Black Diamond, CORAL, and AURORA.

5. The touch panel as set forth in claim 1, wherein a dielectric constant (k) of the low dielectric constant film has a range of 1 to 3.

6. The touch panel as set forth in claim 1, further comprising:
an adhesive layer that is laminated on the active region of the one surface of the transparent substrate.

7. The touch panel as set forth in claim 5, wherein the low dielectric constant film and the adhesive layer are formed as the same layer.

8. The touch panel as set forth in claim 5, wherein the adhesive layer is an optical clear adhesive (OCA).

9. The touch panel as set forth in claim 5, further comprising:
a window glass that is attached to the adhesive layer.

10. A touch panel comprising:
a transparent substrate that is partitioned into an active region and an inactive region outside the active region;
first and second electrodes that are formed in the active region of one surface of the transparent substrate; and
a low dielectric constant film that is formed along a peripheral edge of the active region while being formed in the inactive region of the one surface of the transparent substrate.

11. The touch panel as set forth in claim 10, wherein the low dielectric constant film is made of an organic material or an inorganic material.

12. The touch panel as set forth in claim 11, wherein the organic material includes any one selected from DVS-BCB (divinyl siloxane biszocylclobutene benzocyclobutene), PFCB (perfluoro cyclobutane), and SiLK.

13. The touch panel as set forth in claim 11, wherein the inorganic material includes any one selected from Black Diamond, CORAL, and AURORA.

14. The touch panel as set forth in claim 10, wherein a dielectric constant (k) of the low dielectric constant film has a range of 1 to 3.

15. The touch panel as set forth in claim 10, further comprising:
an adhesive layer that is laminated on the active region of the one surface of the transparent substrate.

16. The touch panel as set forth in claim 15, wherein the low dielectric constant film and the adhesive layer are formed as the same layer.

17. The touch panel as set forth in claim 15, wherein the adhesive layer is an OCA.

18. The touch panel as set forth in claim 10, wherein the transparent substrate is a window glass.
